(19) United States
(12) Patent Application Publication
(10) Pub. No.: US 2025/0370815 A1
(43) Pub. Date: Dec. 4, 2025

(54) MICROSERVICE DISTRIBUTED TRANSACTION CONTROL METHOD

(71) Applicant: Hitachi, Ltd., Tokyo (JP)

(72) Inventor: Tsuneyuki lmaki, Tokyo (JP)

(21) Appl. No.: 19/209,554

(22) Filed: May 15, 2025

(30) Foreign Application Priority Data
May 31, 2024 (JP) 2024-088630

(51) Int. Cl. G06F 9/50

(52) U.S. Cl. CPC G06F 9/5033; G06F 9/5072

(57) ABSTRACT

Provided is a microservice distributed transaction control method enabling an external service that can cooperate to be expanded more than before according to functionality of an external service. An external service 131 is classified into a plurality of types according to a difference in how a function related to a trial request is provided, and executed are a step of specifying a type of the external service 131 cooperating from a description of an external service cooperation processing designation 132, a step of selecting a transaction control unit adapted to a type of the cooperating external service 131 from a plurality of transaction control units 111 to 114 individually adapted to the plurality of types of the external service 131, and a step of executing transaction control between the microservice 104 and the cooperating external service 131 by applying the selected transaction control unit.

### TECHNICAL FIELD

The present invention relates to a microservice distributed transaction control method.

### BACKGROUND ART

In recent years, a design improvement method called system modernization has been emphasized. As a part of system modernization, there is a method of decomposing functions of a monolithic legacy system into microservices operating on a cloud, and operating the microservices in a distributed manner.

In a system having been modernized, various functions are distributed to individual microservices to cooperate with each other. For example, business logic and RDBMS that conventionally run on an application server are microserviced. In addition, a data store such as a data lake is also a target of microservices. Furthermore, external services that operate on an external web server and are accessed via REST API or the like also cooperate with each other as individual microservices.

On the other hand, maintaining consistency of processing among a plurality of microservices operated in a distributed manner has been recognized as a new technical problem. In order to address this problem, a function of controlling a distributed transaction is required in an execution infrastructure of a microservice. As one of the functions, Try-Confirm/Cancel (TCC) is known. The TCC controls a distributed transaction by a transaction coordinator. In addition, the TCC ensures atomicity of a transaction on the premise that each of microservices including an external service is provided with three functions of Try, Confirm, and Cancel. Try is a phase for temporarily executing business processing (generally involving updating of a state). Confirm is a phase for confirming a result of the temporary execution. Cancel is a phase for canceling the temporary execution. A main microservice execution infrastructure supports distributed transaction control among microservices according to this design manner of the TCC.

Patent Literature 1 to 3 discloses distributed transaction control among microservices.

In the technique disclosed in Patent Literature 1, an orchestrator integrally manages a processing flow of the entire business logic. The orchestrator holds an instruction to each microservice and data of an execution result of the instruction as a snapshot. Then, when an instruction to one or more microservices fails, the orchestrator recovers each microservice using the snapshot data. Thereby, the orchestrator ensures result consistency of the transaction. Here, “result consistency” means that while there is a period of inconsistency, the state settles into a consistent state as time passes.

In addition, the technique disclosed in Patent Literature 2 provides a channel for compensation processing (rewinding processing of state update) on the basis of a relationship of messaging (Pub-Sub: publish-subscribe) between microservices. Furthermore, in the technique recited in Patent Literature 2, an execution result of each microservice is reported via the same channel by aspect orientation. Then, the technique recited in Patent Literature 2 ensures result consistency of a transaction by performing retry of the compensation processing on the premise of idempotence of a message. Here, the “idempotence” refers to a property of obtaining the same result even when the same message is transmitted a plurality of times.

In addition, the technique disclosed in Patent Literature 3 employs a method of optimistic parallelism control on the premise that a transaction control target is a CRUD type data store. An optimistic parallelism control library links to subbusiness logic executed on each microservice. In addition, the optimistic parallelism control library holds a parameter of a request as a snapshot for each read request/write request to the data store. Then, the optimistic parallelism control library ensures strong consistency by updating contents of the data store on the basis of the snapshot when the transaction is settled. Here, “strong consistency” means that an inconsistent period cannot be observed from the outside and does not adversely affect execution of other transactions executed at the same time.

### CITATION LIST

### Patent Literature

PTL 1: CN 110502319 A
Patent Literature 2: CN 113900840 A
Patent Literature 3: WO 2023/033153 A

### SUMMARY OF INVENTION

### Technical Problem

Meanwhile, the techniques recited in Patent Literature 1 and Patent Literature 2 are premised on that all microservices including an external service are provided with all the functions of Try, Confirm, and Cancel. Therefore, application to an external service that lacks any of the functions of Try, Confirm, and Cancel is not considered among external services that cannot be modified in general. Even if the techniques recited in Patent Literature 1 and Patent Literature 2 are applicable to an external service that lacks some of the functions described above, ensuring strong consistency is not considered.

In addition, the technique recited in Patent Literature 3 is premised on that a control target for distributed transaction is a CRUD type data store and is operated only via a read/write request. Therefore, in the technique recited in Patent Literature 3, it is not considered that an external service whose function specification is generally defined in the form of REST API is set as a control target for distributed transaction. In other words, the techniques recited in Patent Literature 1 to 3 have a disadvantage that external services that can cooperate with each other are limited in distributed transaction control of microservices.

The present invention has been made in view of such circumstances, and an object of the present invention is to provide a microservice distributed transaction control method enabling an external service that can cooperate to be expanded more than before according to functionality of the external service.

### Solution to Problem

The present invention for solving the above problem is a microservice distributed transaction control method for controlling, as a target, a microservice and an external service cooperating with the microservice, and includes the following steps (a) to (d) executed by a computer:
(a) classifying external services into a plurality of types according to a difference in how a function related to a trial request is provided;
(b) specifying a type of a cooperating external service from description of an external service cooperation processing designation;
(c) selecting, from a plurality of transaction control units individually adapted to the plurality of types of the external services, a transaction control unit adapted to the type of the cooperating external service; and
(d) executing transaction control between the microservice and the cooperating external service by applying the selected transaction control unit.

### Advantageous Effects of Invention

According to the present invention, it is possible to provide a microservice distributed transaction control method enabling an external service that can cooperate to be expanded more than before according to functionality of the external service.

Problems, configurations, and effects other than those described above will be clarified by the following description of an embodiment.

### BRIEF DESCRIPTION OF DRAWINGS

FIG. 1 is a block diagram illustrating a configuration example of a business system according to an embodiment of the present invention.

FIG. 2 is a flowchart illustrating selection operation of a transaction control unit illustrated in FIG. 1.

FIG. 3 is a block diagram illustrating a relationship among the business system, external service cooperation processing designations, and an external service class classifier illustrated in FIG. 1.

FIG. 4 is a flowchart illustrating operation of a transaction control unit (confirmable type) illustrated in FIG. 1.

FIG. 5 is a flowchart illustrating operation of a transaction control unit (back-calculable type) illustrated in FIG. 1.

FIG. 6 is a flowchart illustrating operation of a transaction control unit (delayable type) illustrated in FIG. 1.

FIG. 7 is a flowchart illustrating operation of a transaction control unit (irrevocable type) illustrated in FIG. 1.

FIG. 8 is a data structure diagram illustrating an example of stored in a request information management unit illustrated in FIG. 1.

FIG. 9 is a data structure diagram illustrating an example of data stored in a parallelism control unit illustrated in FIG. 1.

FIG. 10 is a block diagram illustrating an example of a business system to which the embodiment of FIG. 1 is applied.

FIG. 11 is a program configuration diagram illustrating an example of the external service cooperation processing designation illustrated in FIG. 1.

### DESCRIPTION OF EMBODIMENTS

In the following, modes for carrying out the present invention (hereinafter, referred to as “the present embodiment”) will be described with reference to the accompanying drawings. In the present specification and the drawings, components having substantially the same function or configuration are denoted by the same reference numerals, and redundant description is omitted.

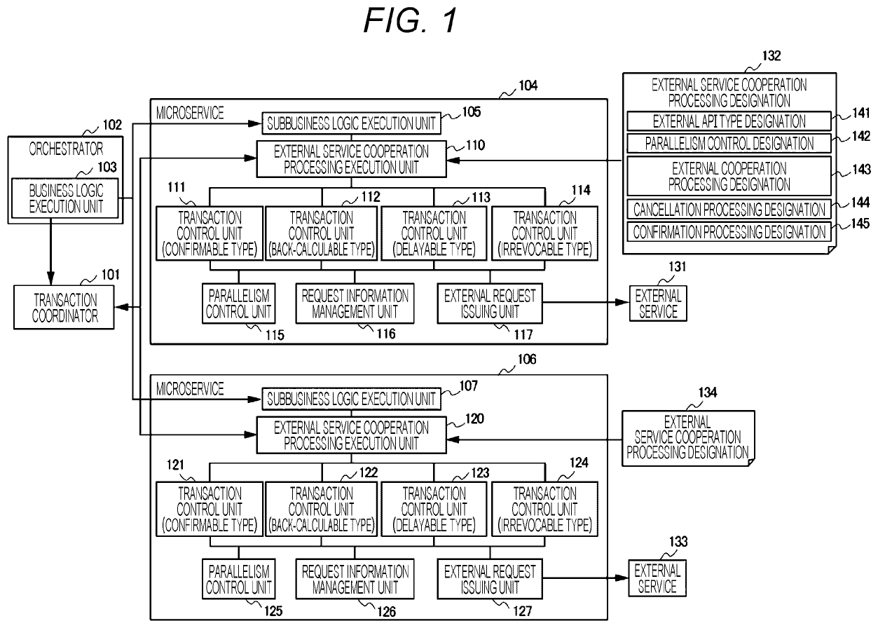

FIG. 1 is a block diagram illustrating a configuration example of a business system according to the present embodiment.

As illustrated in FIG. 1, the business system according to the present embodiment includes a transaction coordinator 101 and an orchestrator 102. In addition, the business system has a plurality of microservices 104 and 106. Furthermore, the business system cooperates with external services 131 and 133.

Among them, the transaction coordinator 101 directs a transaction executed by the plurality of microservices 104 and 106 in a distributed manner. The orchestrator 102 accepts a service request from a client (not shown) and executes business logic corresponding to the service. The business logic defines an overall business flow of the service requested by the client. The microservices 104 and 106 execute subbusiness logic corresponding to partial processing of the business logic. The external services 131 and 133 operate in cooperation with each subbusiness logic.

The orchestrator 102 includes a business logic execution unit 103 that executes business logic. In addition, the microservices 104 and 106 include subbusiness logic execution units 105 and 107 that execute subbusiness logic, respectively.

The business logic execution unit 103 executes remote call to the subbusiness logic execution units 105 and 107 to implement processing of the entire business flow. The subbusiness logic execution units 105 and 107 cooperate with the external services 131 and 133. Therefore, the subbusiness logic execution units 105 and 107 issue a remote call (hereinafter referred to as “trial request”) to the external services 131 and 133 in the subbusiness logic. At this time, external service cooperation processing execution units 110 and 120 mediate the trial request from the subbusiness logic execution units 105 and 107 to the external services 131 and 133 while executing control related to the transaction.

Here, among the plurality of external services 131 and 133, a part of the external service, 131 (133) may fail to process the trial request. In this case, the external service cooperation processing execution units 110 and 120 need to maintain transaction consistency among the microservices including the external services 131 and 133. Therefore, for the entire external service 133 (131) that has successfully processed the trial request, transaction control units 121 to 124 (111 to 114) execute control to return to a state before the trial request is processed.

Here, the failure of the trial request includes a fraud of the request itself to the external service 131 (133). It is, for example, a case where tickets have been sold out in a ticket issuing service. The failure of the trial request also includes an operation failure of the external service 131 (133). For example, there is a case where the ticket issuing service is inaccessible due to overloading or a failure.

In the present embodiment, four types of transaction control units 111 to 114, and 121 to 124 are provided. First, a breakdown of the four types will be described.

When completing a course of the business logic corresponding to the service request received from the client, the business logic execution unit 103 notifies the transaction coordinator 101 of timing of the completion. Upon receiving this notification, the transaction coordinator 101 instructs the external service cooperation processing execution units 110 and 120 to settle the transaction (issue a settlement instruction).

Prior to issuance of the settlement instruction, the transaction coordinator 101 counts whether each trial request to the external services 131 and 133 has succeeded or failed via the external service cooperation processing execution units 110 and 120. As a result of this counting, when all the trial requests have succeeded, the transaction coordinator 101 issues a settlement instruction of Confirm (confirmation request). On the other hand, when at least one trial request has failed, the transaction coordinator 101 issues a settlement instruction of Cancel (cancel request).

Here, the external services 131 and 133 do not necessarily have a function corresponding to the confirmation request and the cancel request. In this embodiment, external services are classified so as to correspond to different functionalities of the external services. In other words, in the present embodiment, the external services are classified into the following four types on the basis of how the external services 131 and 133 are provided with a function related to a trial request.

[Confirmable type]: An external service that accepts both the cancel request and the confirmation request.

[Back-calculable type]: An external service that opens a request having an action of canceling a side effect in an external service caused by execution of a trial request.

Here, the “side effect” refers to an influence that occurs in a state of the external service. For example, in account balance management, a deposit withdrawal request involves a side effect caused by a change of the account balance. On the other hand, a request for balance confirmation does not affect the account balance, and thus does not involve a side effect.

[Delayable type]: An external service allowing execution of a trial request to be postponed until settlement of a transaction.

[Irrevocable type]: An external service that corresponds to none of the above three types.

The microservices 104 and 106 include the transaction control units (confirmable type) 111 and 121, the transaction control units (back-calculable type) 112 and 122, the transaction control units (delayable type) 113 and 123, and the transaction control units (irrevocable type) 114 and 124, respectively.

The external service cooperation processing execution units 110 and 120 select the transaction control units 111 to 114, and 121 to 124 to be used, respectively, for each type of the external service described above. Then, the external service cooperation processing execution units 110 and 120 respectively issue a predetermined request to the external services 131 and 133 via external request issuing units 117 and 127 using the selected transaction control units.

In addition, the microservices 104 and 106 include request information management units 116 and 126 and parallelism control units 115 and 125, respectively. The request information management units 116 and 126 hold information (an argument of a request) necessary for issuing a request to the external services 131 and 133. The request is a cancel request, a confirmation request, or a postponed trial request.

The argument of the request is temporarily held until the transaction is settled. Furthermore, the parallelism control units 115 and 125 perform control for ensuring separability of the transaction. The transaction control units 111 to 114, and 121 to 124 commonly use the request information management units 116 and 126 and the parallelism control units 115 and 125, respectively.

The external service cooperation processing execution units 110 and 120 select and selectively use the transaction control units 111 to 114, and 121 to 124 to be applied on the basis of external service cooperation processing designations 132 and 134, respectively. The external service cooperation processing designations 132 and 134 include an external API type designation 141, a parallelism control designation 142, external an cooperation processing designation 143, a cancellation processing designation 144, and a confirmation processing designation 145.

The external API type designation 141 designates a type of the external services 131 and 133 (any one of the above four types). The parallelism control designation 142 designates information necessary for control by the parallelism control units 115 and 125. The external cooperation processing designation 143 defines a trial request issuing method. The cancellation processing designation 144 defines a cancel request issuing method. The confirmation processing designation 145 defines a confirmation request issuing method.

In addition, the parallelism control designation 142 designates an identifier for designating a processing target in the trial request among resources managed by the external services 131 and 133. The identifier is designated from available data among arguments of the trial request. The parallelism control units 115 and 125 perform exclusive control when a plurality of trial requests is simultaneously issued using the same identifier as a lock key. Thereby, the parallelism control units 115 and 125 ensure the separability of the transaction.

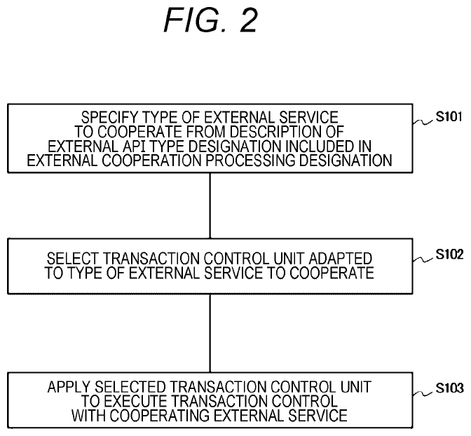

As illustrated in FIG. 2, the external service cooperation processing execution units 110 and 120 specify a type of the external services 131 and 133 to cooperate from the description of the external API type designation 141 (S101). Furthermore, the external service cooperation processing execution units 110 and 120 select a transaction control unit adapted to the type of the external services 131 and 133 to cooperate from the plurality of transaction control units 111 to 114, and 121 to 124 described above (S102). Then, the external service cooperation processing execution units 110 and 120 apply the selected transaction control unit to execute the transaction control with the cooperating external services 131 and 133 (S103).

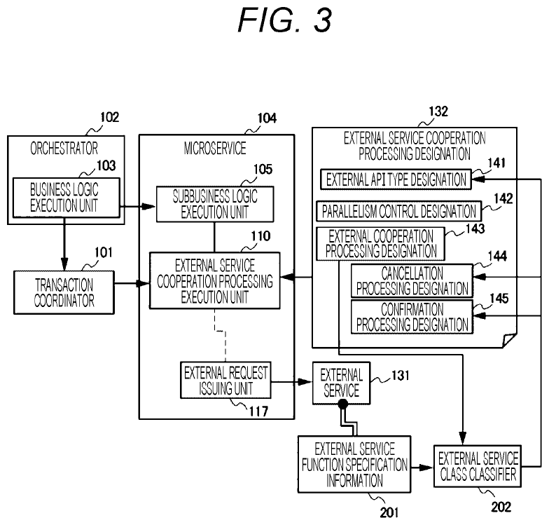

FIG. 3 illustrates a relationship among the external service cooperation processing designation 132, an external service class classifier 202 that automates a part of the definition, and a configuration of the business system.

The external service class classifier 202 automatically generates the external API type designation 141, the cancellation processing designation 144, and the confirmation processing designation 145. Among them, the cancellation processing designation 144 and the confirmation processing designation 145 are automatically generated as necessary.

The external service class classifier 202 uses the definition of the external cooperation processing designation 143 and an external service function specification information 201 as inputs for automatic generation. The external service function specification information 201 is specification information of a request opened by the external service 131. The specification information includes, for example, an URI of the REST API of each request, a JSON structure serving as an argument of the request, a field name, and the like.

Automatic generation of the external API type designation 141, the cancellation processing designation 144, and the confirmation processing designation 145 can be realized by mechanically estimating operation of the trial request and presence and operation of the cancel request and the confirmation request corresponding to the trial request. The mechanical estimation can be performed on the basis of an end character string of the URI of the trial request issued on the basis of the external cooperation processing designation 143, the structure of the JSON argument, and the field name. A request name is generally recited in the end character string of the URI of the trial request.

The present embodiment is not limited by the procedure of the mechanical estimation, and an example will be described below. The external service class classifier 202 determines the external API type designation 141 on the basis of the external service function specification information 201 which is generally opened.

In a case where the determination result is the confirmable type or the back-calculable type, the external service class classifier 202 generates the cancellation processing designation 144 on the basis of the external service function specification information 201. Furthermore, in a case where the determination result is the confirmable type, the external service class classifier 202 generates the confirmation processing designation 145 on the basis of the external service function specification information 201.

More specifically, the external service function specification information 201 may include information as to whether or not a cancellation function is provided for the trial request. In addition, the external service function specification information 201 may include information as to whether or not the function of canceling a side effect caused by execution of a trial request is provided. When an external service to be determined has the cancellation function, the external service class classifier 202 can determine that the external service is a confirmable type external service. In addition, the external service class classifier 202 can determine that the external service to be determined is a back-calculable type external service when the external service has the function of canceling a side effect.

In addition, since specifications of cancellation processing are recited in the external service function specification information 201, the external service class classifier 202 generates the cancellation processing designation 144. Furthermore, since specifications of confirmation processing are recited in the external service function specification information 201, the external service class classifier 202 generates the confirmation processing designation 145. Thus, the external service class classifier 202 can automatically generate the external API type designation 141, the cancellation processing designation 144, and the confirmation processing designation 145.

Here, in FIG. 3, illustration of the transaction control units 111 to 114, the parallelism control unit 115, and the request information management unit 116 is omitted. Furthermore, while FIG. 3 illustrates a pair of the microservice 104 and the external service cooperation processing designation 132, a pair of other microservice 106 and other external service cooperation processing designation 134 can be similarly configured.

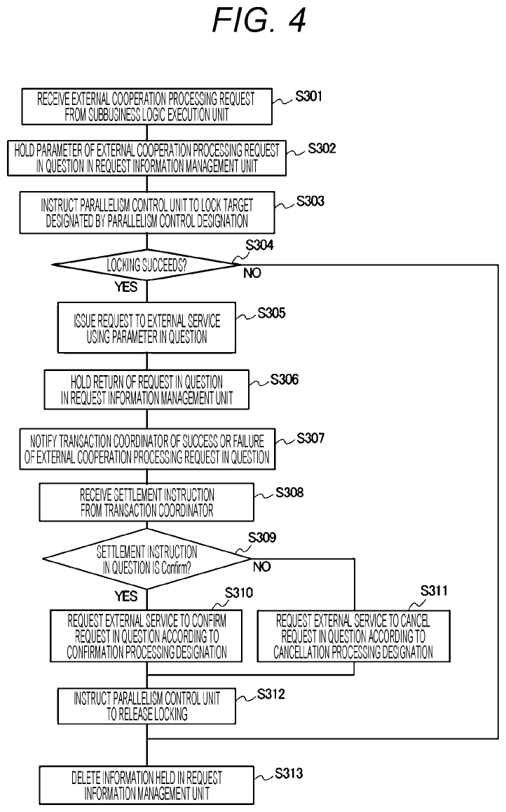

FIG. 4 is a flowchart illustrating operation of the transaction control unit (confirmable type) 111. Although in the following, operation of one microservice 104 will be described, the same applies to the other microservice 106. In addition, the “transaction control unit (confirmable type) 111” is appropriately abbreviated as the “transaction control unit 111”.

The transaction control unit 111 first receives an external cooperation processing request from the subbusiness logic execution unit 105 (S301). The external cooperation processing request is a request for issuing a trial request to the external service 131 according to the external cooperation processing designation 143.

At this time, the transaction control unit 111 holds a parameter of the external cooperation processing request (the argument of the trial request: JSON data or the like) in the request information management unit 116 (S302). Furthermore, the transaction control unit 111 instructs the parallelism control unit 115 to perform exclusive control on the basis of a lock key defined by the parallelism control designation 142 (S303).

When the locking for the exclusive control succeeds (YES in S304), the transaction control unit 111 issues a trial request to the external service 131 using the parameter of the external cooperation processing request described above (S305). In addition, the transaction control unit 111 also holds a return of the trial request in the request information management unit 116 (S306). Furthermore, the transaction control unit 111 notifies the transaction coordinator 101 of the success or failure of the trial request (S307).

When a course of the processing of the business logic is completed, and the process proceeds to a transaction settlement phase, the transaction control unit 111 receives the settlement instruction from the transaction coordinator 101 (S308). In a case where the settlement instruction received in Step S308 is Confirm (YES in S309), the transaction control unit 111 issues the confirmation request to the external service 131 according to the confirmation processing designation 145 (S310). On the other hand, in a case where it is not Confirm in Step S309 (NO in S309), the transaction control unit 111 issues the cancel request to the external service 131 according to the cancellation processing designation 144 (S311).

Finally, the transaction control unit 111 causes the parallelism control unit 115 to release the locking by the exclusive control instructed in Step S303 (S312). Then, the transaction control unit 111 deletes the information held in the request information management unit 116 (S313), and ends the transaction.

On the other hand, in a case where the locking does not succeed in Step S304 (NO in S304), the process immediately proceeds to Step S313 to end the transaction. Here, as a modification, Steps S303 and S304 may be repeated until locking succeeds in Step S304.

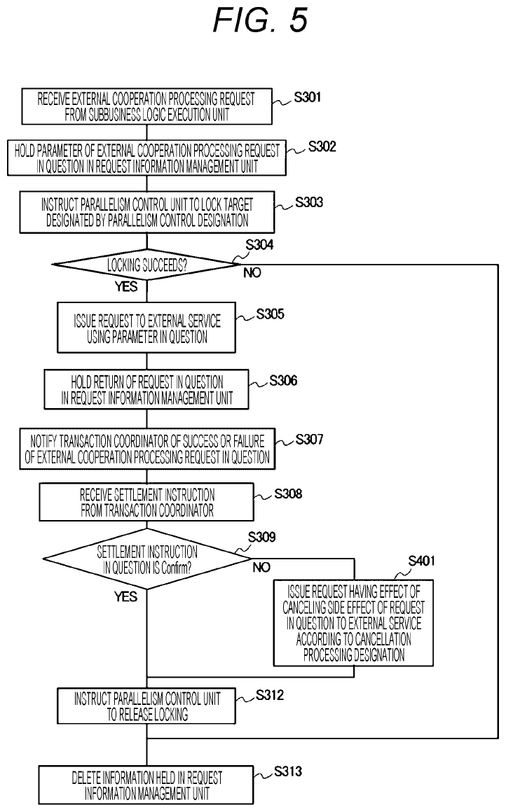

FIG. 5 is a flowchart illustrating operation of the transaction control unit (back-calculable type) 112. Although in the following, operation of one microservice 104 will be described, the same applies to the other microservice 106. In addition, the “transaction control unit (back-calculable type) 112” is appropriately abbreviated as the “transaction control unit 112”.

In FIG. 5, operations in Steps S301 to S309, S312, and S313 are the same as those in FIG. 4, and thus redundant description will be omitted. In a case of Confirm in Step S309 (YES in S309), the process directly proceeds to Step S312. On the other hand, in a case of Cancel in Step S309 (NO in S309), the transaction control unit 112 issues the cancel request to the external service 131 according to the cancellation processing designation 144 (S401). The cancel request here is a request having an effect of canceling a side effect of the corresponding trial request.

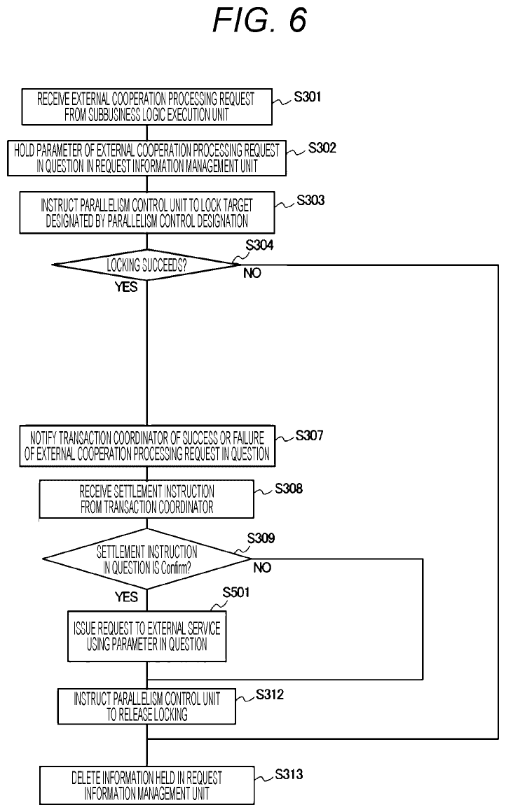

FIG. 6 is a flowchart illustrating operation of the transaction control unit (delayable type) 113. Although in the following, operation of one microservice 104 will be described, the same applies to the other microservice 106. In addition, the “transaction control unit (delayable type) 113” is appropriately abbreviated as the “transaction control unit 113”.

In FIG. 6, operations in Steps S301 to S309, S312, and S313 are the same as those in FIG. 4, and thus redundant description will be omitted. However, processing corresponding to Steps S305 and S306 in FIG. 4 is not executed. Furthermore, in processing corresponding to Step S307 in FIG. 4, the transaction control unit 113 notifies the transaction coordinator 101 that the trial request has succeeded as temporary processing.

In a case of Confirm in Step S309 (YES in S309), the transaction control unit 113 issues the trial request to the external service 131 using the parameter of the external cooperation processing request held in Step S302 as an argument (S501). On the other hand, in a case of Cancel (NO in S309), the transaction control unit 113 directly proceeds to Step S312.

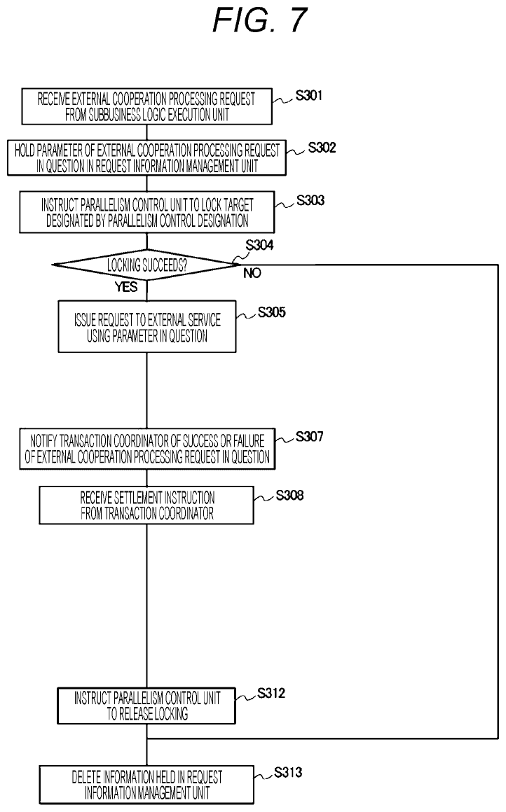

FIG. 7 is a flowchart illustrating operation of the transaction control unit (irrevocable type) 114. Although in the following, operation of one microservice 104 will be described, the same applies to the other microservice 106. Furthermore, the “transaction control unit (irrevocable type) 114” is appropriately abbreviated as the “transaction control unit 114”.

In FIG. 7, operations in Steps S301 to S308, S312, and S313 are the same as those in FIG. 4, and thus redundant description will be omitted. However, the transaction control unit 114 does not execute processing corresponding to Step S306 in FIG. 4. In addition, the transaction control unit 114 does not execute processing at the time of transaction settlement either, the processing corresponding to Steps S309 to S311 in FIG. 4.

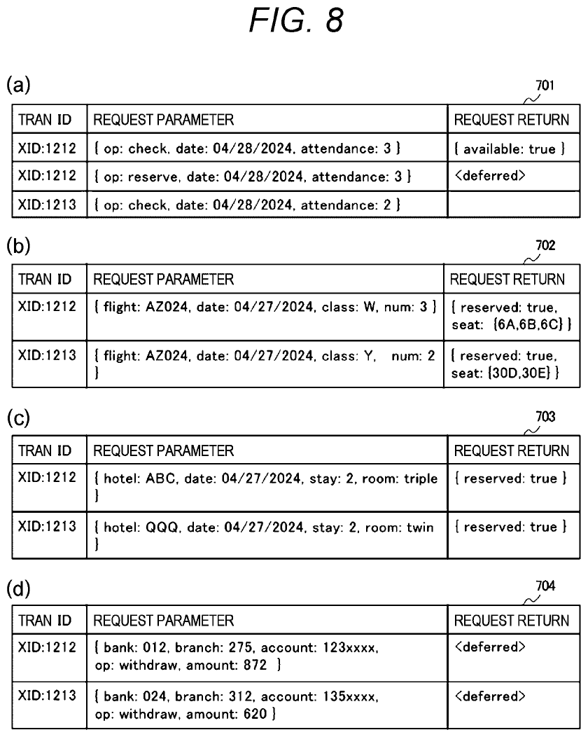

Next, an operation example of the business system will be described with reference to FIGS. 8 to 10.

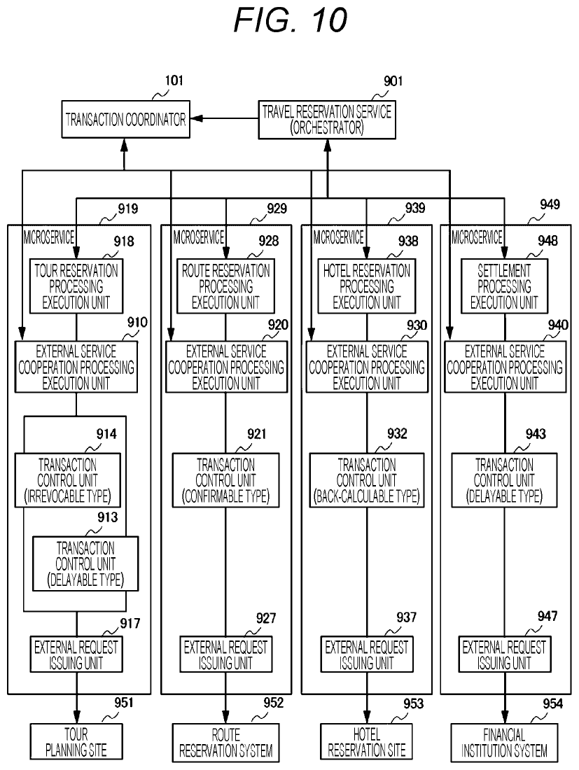

The business system illustrated in FIG. 10 is a system that provides a reservation service for a tour in accordance with holding of an event. A travel reservation service 901 as the orchestrator 102 receives, from a client (not shown), a request for a reservation for a tour. In the present embodiment, four microservices 919 to 949 cooperate with four external services 951 to 954, respectively. The travel reservation service 901 causes each of the microservice 919 to 949 to share and process reservation processing of the tour requested by the client.

Each of the microservices 919 to 949 cooperates with a tour planning site 951, a route reservation system 952, a hotel reservation site 953, and a financial institution system 954 as the external services. Processing shared by the microservices 919 to 949 is executed by a tour reservation processing execution unit 918, a route reservation processing execution unit 928, a hotel reservation processing execution unit 938, and a settlement processing execution unit 948 as subbusiness logic execution units, respectively.

The subbusiness logic execution units 918, 928, 938, and 948 cooperate with the external services 951, 952, 953, and 954 via external service cooperation processing execution units 910, 920, 930, and 940, transaction control units 913, 914, 921, 932, and 943, and external request issuing units 917, 927, 937, and 947, respectively.

FIG. 8 illustrates an example of data held by the request information management unit (not illustrated in FIG. 10) in the business system of FIG. 10. FIG. 8(a) illustrates a data structure 701 held by the request information management unit corresponding to the external service cooperation processing execution unit 910. FIG. 8(b) illustrates a data structure 702 held by the request information management unit corresponding to the external service cooperation processing execution unit 920. FIG. 8(c) illustrates a data structure 703 held by the request information management unit corresponding to the external service cooperation processing execution unit 930. FIG. 8(d) illustrates a data structure 704 held by the request information management unit corresponding to the external service cooperation processing execution unit 940.

In the examples of the data structures 701 to 704, it is assumed that a transaction having a transaction identifier (tran ID) of “XID: 1212” and a transaction having a transaction identifier (tran ID) of “XID: 1213” are processed almost simultaneously in parallel. It is, however, assumed that “XID: 1212” is issued slightly earlier. Here, it is assumed that the transactions of “XID: 1212” and “XID: 1213” correspond to tour participation requests from a customer A and a customer B, respectively.

The data structure 701 represents information held by the request information management unit in cooperation with the tour planning site 951. A first line of a request parameter represents a request (op: check) by the customer A for inquiring whether three participants are allowed or not for an event held on Apr. 28, 2024. A second line of the request parameter represents a request (op: reserve) for making a reservation in response to an inquiry result (“available: true” in the first line, i.e., participation is possible). A third line of the request parameter represents a request by the customer B for inquiring whether or not two participants are allowed for the same day.

In addition, a first line of a request return represents that participation is possible as described above. A second line of the request return “<deferred>” represents that since the tour planning site 951 as an external service is of a delayable type, issuance of a request is postponed until transaction settlement. In addition, a third line (blank) of the request return indicates that the request return is yet to be received. Here, in a case where the event is filled up with the participant due to the request of the customer A, the third line of the request return indicates “available: false”, i.e., that the participation is impossible. In that case, no reservation (op: reserve) request is issued.

The data structure 702 represents information held by the request information management unit in cooperation with the route reservation system 952. A first line of a request parameter represents route reservation on the day before the event related to the customer A. A second line of the request parameter represents reservation related to the customer B. The request parameter uses a flight number, a date, a class of a seat, and the number of people as parameters. The request return indicates a value of a secured seat number for each request.

The data structure 703 represents information held by the request information management unit in cooperation with the hotel reservation site 953. A first line of the request parameter represents an accommodation reservation related to the customer A for staying for two nights from the day before the event. A second line of the request parameter represents reservation related to the customer B. Each request parameter uses a lodging facility name, a date, the number of days of stay, and a grade of a room as parameters. The request return indicates that the reservation is made for each request.

The data structure 704 represents information held by the request information management unit in cooperation with the financial institution system 954. A first line of the request parameter represents a payment request related to the customer A. A second line of the request parameter represents a payment request related to the customer B. Each request parameter uses a bank code, a branch code, an account number, a transaction, and an amount as parameters. The request return indicates that each request is postponed until the transaction is settled.

These requests can be independently executed by the respective external service 951 to 954. However, in a case where execution of one of the external services has failed, the other external services (which have succeeded in execution) must be treated as not having been executed. For example, in a case where the third line of the request return of the data structure 701 is “available: false”, i.e., in a case where the customer B cannot participate in the tour planning site 951, it is necessary to determine that there is no request issued to the other external services 952, 953, and 954 for the customer B. Therefore, when the transaction of “XID: 1213” is settled, the cancel request is issued to the external services of the confirmable type and the back-calculable type. In addition, for the delayable type external service, the request whose execution has been postponed is discarded as it is.

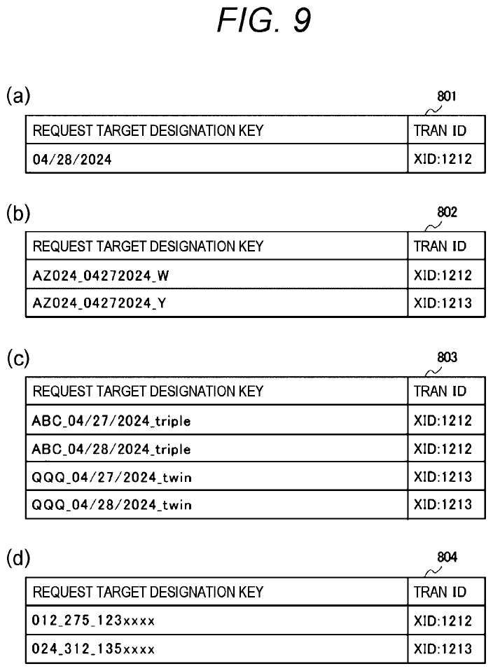

FIG. 9 illustrates an example of data held by the parallelism control unit (not illustrated) in the business system of FIG. 10. FIG. 9(a) illustrates a data structure 801 held by the parallelism control unit corresponding to the external service cooperation processing execution unit 910. FIG. 9(b) illustrates a data structure 802 held by the parallelism control unit corresponding to the external service cooperation processing execution unit 920. FIG. 9(c) illustrates a data structure 803 held by the parallelism control unit corresponding to the external service cooperation processing execution unit 930. FIG. 9(d) illustrates a data structure 804 held by the parallelism control unit corresponding to the external service cooperation processing execution unit 940. In the respective data structures 801 to 804, as a request target designation key (lock key), two or more of the same values cannot be stored.

The data structure 801 represents a lock key for the parallelism control unit to execute exclusive control in cooperation with the tour planning site 951. Until whether or not the customer A can participate in the event held on Apr. 28, 2024 is confirmed, it is necessary to suppress another customer to participate in the event on the day. Thus, the data structure 801 stores date information as the lock key. As illustrated in FIG. 8(a), the customer B also requests to participate in the event on the day. However, since the date matches with the request target designation key in the first line of the data structure 801, the transaction ID of the customer B cannot be added to the data structure 801. As a result, execution of the transaction of “XID: 1213” related to the customer B is suppressed.

On the other hand, the transaction ID “XID: 1212” related to the customer A is recorded in the data structure 801. Then, since reservation processing (op: reserve) after the inquiry about whether or not the customer A can participate in FIG. 8(a) also corresponds to the same transaction ID “XID: 1212”, the reservation processing can be executed.

The data structure 802 represents a lock key for the parallelism control unit to execute exclusive control in cooperation with the route reservation system 952. A first line of the request target designation key is a lock key related to the route reservation of the customer A. A second line of the request target designation key indicates a lock key related to the reservation of the customer B. The lock key is a combination of a flight number, date, and a seat class. Since different classes are reserved by the customer A and the customer B, it is possible to add both entries to the data structure 802. As a result, transactions of both the customers can be executed without being mutually suppressed.

The data structure 803 represents a lock key for the parallelism control unit to execute exclusive control in cooperation with the hotel reservation site 953. The first and second lines of the request target designation key are lock keys related to accommodation reservation of the customer A. In addition, third and fourth lines of the request target designation key indicate lock keys related to accommodation reservation of the customer B. The lock key is a combination of a lodging facility name, date, and a grade of a room. Since different lodging facilities and grades are reserved for the customer A and the customer B, it is possible to add both entries to the data structure 803. As a result, transactions of both the customers can be executed without being mutually suppressed.

The data structure 804 represents a lock key for the parallelism control unit to execute exclusive control in cooperation with the financial institution system 954. A first line of the request target designation key is a lock key related to withdrawal of the customer A. A second line of the request target designation key indicates a lock key related to withdrawal of the customer B. The lock key is a combination of a bank code, a branch code, and an account number. Since the customer A and the customer B have different account numbers, it is possible to add both entries to the data structure 804. As a result, transactions of both the customers can be executed without being mutually suppressed. The parallelism control unit operates while using the data structures 801 to 804 so that each exclusive control is performed in the above manner.

Here, since the inquiry (op: check) about the participation to the tour planning site 951 is processing of only reference, neither a cancel request nor a confirmation request exists. In addition, since the result of the inquiry is used by the subbusiness logic execution unit 918, postponement is not possible. Therefore, the irrevocable type transaction control unit 914 is used for the inquiry about whether the customer can participate. On the other hand, in the reservation processing (op: reserve), even if the event participation reserved once cannot be canceled, it is possible to determine in advance whether or not the reservation can be made from the result of the inquiry about whether or not the customer can participate. Therefore, it is possible to postpone the execution of the reservation processing until the settlement of the transaction. Therefore, the delayable type transaction control unit 913 is used for the reservation processing.

In addition, since for the route reservation system 952, the phases of temporary reservation and reservation confirmation are divided, the confirmable type transaction control unit 921 is used. In addition, since for the hotel reservation site 953, while a contract is fixed at the time of reservation, the reservation can be cancelled before staying, the back-calculable type transaction control unit 932 is used. Since for the financial institution system 954, payment only needs to be performed only when the transaction is finally settled as Confirm, the delayable type transaction control unit 943 is used. The external service cooperation processing designation 132 corresponding to each of the microservices 919 to 949 is described so that an adaptable transaction control unit is selected as described above.

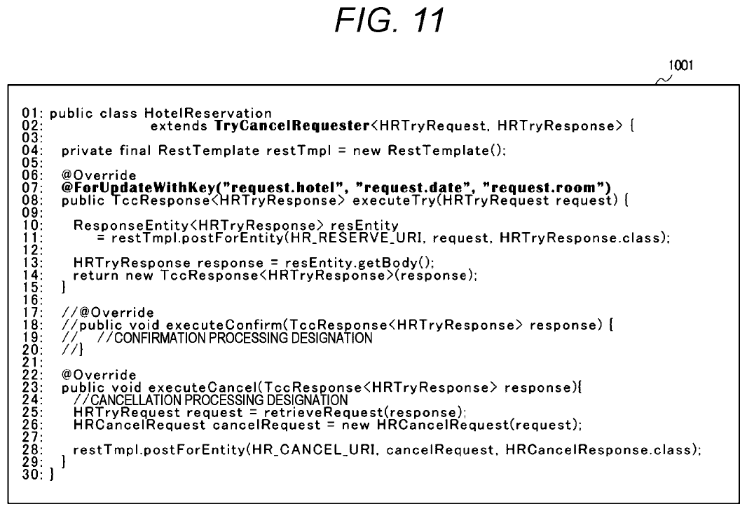

Text information 1001 in FIG. 11 represents an example of the external service cooperation processing designation 132 corresponding to the business system in FIG. 10. The text information 1001 is a program described in Java (registered trademark). The example of FIG. 11 shows the external service cooperation processing designation 132 corresponding to the microservice 939 (hotel reservation processing execution unit 938).

Designation of an inherited class in a line 0 corresponds to the external API type designation 141. In this example, the back-calculable type transaction control unit 932 is designated. Definition of an executeTry method in lines 8 to 15 corresponds to the external cooperation processing designation 143. The annotation on the line 7 applied to the method corresponds to the parallelism control designation 142.

In this example, it is defined that a combination of values of hotel, date, room, and field of a request, which are parameters of the external cooperation processing designation 143, is used as a lock key. Definition of an executeCancel method in lines 23 to 29 corresponds to the cancellation processing designation 144. Definition of an executeConfirm method in lines 18 to 20 corresponds to the confirmation processing designation 145. However, in this example, since the external API type designation 141 designates the back-calculable type, the confirmation processing designation 145 is unnecessary. Therefore, the confirmation processing designation 145 is commented out.

Finally, the operations of the transaction coordinator 101, the orchestrator 102, and the microservices 104 and 106 described above, including their internal elements, are implemented by a computer executing a predetermined program. Furthermore, the external service cooperation processing designation 132, the data structures 701 to 704 held by the request information management units 116 and 126, and the data structures 801 to 804 held by the parallelism control units 115 and 125 are stored in a storage region of a storage device. The above program may be processed in a distributed manner by a plurality of computers. Furthermore, the storage region may be distributed to a plurality of storage devices. The distributed plurality of computers and plurality of storage devices may cooperate via a communication device and a computer network. The same applies to the business system illustrated in FIG. 10.

According to the present embodiment described in the foregoing, services are classified into a plurality of types according to a difference in how the function related to the trial request is provided, and the transaction control unit adapted to the type of the external service is selected and applied. Therefore, it is possible to expand types of external services that can cooperate more than before.

In addition, since the type of the external service to cooperate is specified from the description of the external service cooperation processing designation, it is possible to cope with cooperation with a new external service by changing the description of the external service cooperation processing designation, and it is possible to suppress development man-hours in cooperation with the external service.

In addition, since information necessary for issuing the cancel request and the confirmation request to the external service is temporarily held in the request information management until the transaction is completed, it is possible to ensure strong consistency of distributed transaction control even between microservices cooperating with a different type of external service.

Furthermore, since the exclusive control between transactions is executed using the identifier for specifying a processing target of the transaction control as the lock key, it is possible to ensure strong consistency of the distributed transaction control between microservices cooperating with a different type of external service.

In addition, since four types of the transaction control units are provided, the confirmable type, the back-calculable type, the delayable type, and the irrevocable type not corresponding these, it is possible to cooperate with any type of external service.

In addition, since the external service cooperation processing designation includes the descriptions of the external API type designation, the parallelism control designation, the external cooperation processing designation, the cancellation processing designation, and the confirmation processing designation, not only the designation of the transaction control unit to be used but also the operation and the like of the parallelism control unit can be set by changing the description of the external service cooperation processing designation.

Furthermore, since there is provided a function of automatically generating the external service cooperation processing designation on the basis of the function specification information of the external service, it is possible to further reduce development man-hours when cooperating with a new external service as compared with a case where the external service cooperation processing designation is manually set.

As described in the foregoing, according to the present embodiment, in modernizing a system that requires cooperation with an external service, it is possible to cooperate with various external services including a system that does not satisfy a design manner of the TCC. It is also possible to realize set-up of a distributed transaction that ensures strong consistency while reducing development man-hours.

Note that the present invention is not limited to the above-described embodiments, and it is obvious that various other application examples and modifications can be taken without departing from the gist of the present invention recited in the claims.

For example, the above embodiments have been described with respect to the configuration of the system in detail and specifically for easy understanding of the present invention, and are not necessarily limited to those having all the described configurations. In addition, it is also possible to add, delete, and replace other configurations with respect to a part of the configurations of the present embodiments.

In addition, control lines and information lines are shown that are considered to be necessary for the description, and all the control lines and the information lines are not necessarily shown because of a product. In practice, it may be considered that almost all the configurations are connected to each other.

For example, a plurality of components located in a single microservice in this embodiment may all operate on a single calculator, or may operate on a plurality of different calculators. Furthermore, a plurality of transaction control units operating on two or more different calculators may be connected to a single parallelism control unit. Similarly, a plurality of transaction control units operating on two or more different calculators may be connected to a single request information management unit. Furthermore, the orchestrator and the transaction coordinator may operate on a single calculator as a single component having both functions.

Furthermore, although in the above embodiment, the configuration in which one microservice 104 cooperates with one external service 131 has been described, one microservice 104 may cooperate with a plurality of external services. In a case where one microservice 104 cooperates with n external services, n sets of the external service cooperation processing execution unit 110, the transaction control units 111 to 114, the parallelism control unit 115, the request information management unit 116, and the external request issuing unit 117 may be provided.

### REFERENCE SIGNS LIST

101 transaction coordinator
102 orchestrator
103 business logic execution unit
104, 106, 919, 929, 939, 949 microservice
105, 107 subbusiness logic execution unit
110, 120, 910, 920, 930, 940 external service cooperation processing execution unit
111, 121, 921 transaction control unit (confirmable type)
112, 122, 932 transaction control unit (back-calculable type)
113, 123, 913, 943 transaction control unit (delayable type)
114, 124, 914 transaction control unit (irrevocable type)
115, 125 parallelism control unit
116, 126 request information management unit
117, 127, 917, 927, 937, 947 external request issuing unit
131, 133 external service
132, 134, 910, 920, 930, 940 external service cooperation processing designation
141 external API type designation
142 parallelism control designation
143 external cooperation processing designation
144 cancellation processing designation
145 confirmation processing designation
201 external service function specification information
202 external service class classifier
701 to 704, 801 to 804 data structure
901 travel reservation service (orchestrator)
918 tour reservation processing execution unit (subbusiness logic execution unit)
928 route reservation processing execution unit (subbusiness logic execution unit)
938 hotel reservation processing execution unit (subbusiness logic execution unit)
948 settlement processing execution unit (subbusiness logic execution unit)
951 tour planning site (external service)
952 route reservation system (external service)
953 hotel reservation site (external service)
954 financial institution system (external service)
1001 text information

1. A microservice distributed transaction control method for controlling, as a target, a microservice and an external service cooperating with the microservice,
wherein the external service is classified into a plurality of types according to a difference in how a function related to a trial request is provided,
the method comprising:
a step of specifying a type of the cooperating external service from a description of an external service cooperation processing designation;
a step of selecting, from a plurality of transaction control units individually adapted to the plurality of types of the external service, a transaction control unit adapted to a type of the cooperating external service; and
a step of executing transaction control between the microservice and the cooperating external service by applying a selected transaction control unit.

2. The microservice distributed transaction control method according to claim 1, further comprising a step of temporarily holding information necessary for issuing a cancel request and a confirmation request to the external service in a request information management unit until a transaction is completed.

3. The microservice distributed transaction control method according to claim 2, further comprising a step of executing exclusive control between transactions using an identifier that specifies a processing target of the transaction control as a lock key.

4. The microservice distributed transaction control method according to claim 1, wherein
the plurality of transaction control units includes:
a transaction control unit (confirmable type) adapted to a case where the external service opens both a cancel request and a confirmation request;
a transaction control unit (back-calculable type) adapted to a case where the external service opens a request having an action of canceling a side effect in the external service caused by execution of the trial request;
a transaction control unit (delayable type) adapted to a case where execution of the trial request of the external service can be postponed until settlement of a transaction; and
a transaction control unit (irrevocable type) applied in a case where the transaction control unit is adapted to none of the transaction control units.

5. The microservice distributed transaction control method according to claim 4, wherein
the transaction control unit (confirmable type) includes:
a step of temporarily holding request parameter information at the time of issuing a trial request and request return information from the external service for the trial request in a request information management unit;
a step of creating a request parameter from the information temporarily held in the request information management unit in a case where at the time of settlement of a transaction, a settlement destination is Confirm, and issuing a confirmation request; and
a step of creating a request parameter from the temporarily held information and issuing a cancel request in a case where the settlement destination is Cancel.

6. The microservice distributed transaction control method according to claim 4, wherein
the transaction control unit (back-calculable type) includes:
a step of temporarily holding request parameter information at the time of issuing a trial request and request return information from an external service for the trial request in a request information management unit; and
a step of refraining from issuing a request in a case where at the time of settlement of a transaction, settlement destination is Confirm, and creating a request parameter from the information temporarily held in the request information management unit and issuing a cancel request in a case where a settlement destination is Cancel.

7. The microservice distributed transaction control method according to claim 4, wherein
the transaction control unit (delayable type) includes:
a step of temporarily holding request parameter information for issuing a trial request in a request information management unit without issuing the trial request itself; and
a step of issuing a trial request to the external service by using, as it is, the request parameter information for issuing a trial request temporarily held in the request information management unit in a case where at the time of settlement of a transaction, a settlement destination is Confirm.

8. The microservice distributed transaction control method according to claim 7, wherein the transaction control unit (delayable type) refrains from issuing a request in a case where at the time of settlement of a transaction, a settlement destination is Cancel.

9. The microservice distributed transaction control method according to claim 4, wherein while including a step of temporarily holding request parameter information at the time of issuing a trial request in a request information management unit, the transaction control unit (irrevocable type) refrains from issuing a request at the time of settlement of a transaction.

10. The microservice distributed transaction control method according to claim 3, wherein
the microservice includes a step of executing cooperation operation with the external service according to an external service cooperation processing designation, and
the external service cooperation processing designation includes:
an external API type designation that designates a type of external service to cooperate with;
a parallelism control designation that designates a method of generating information to be used as the lock key from a parameter of the trial request;
an external cooperation processing designation that designates a procedure for calling the trial request to the external service;
a cancellation processing designation that designates a procedure for calling a cancel request at the time of settlement of a transaction; and
a confirmation processing designation that designates a procedure for calling a confirmation request at the time of settlement of a transaction.

11. The microservice distributed transaction control method according to claim 10, comprising:
a step of determining the external API type designation on the basis of function specification information of the external service that is generally opened;
a step of generating the cancellation processing designation on the basis of the function specification information in a case where a result of the determination is a designation of the transaction control unit (confirmable type) or a designation of the transaction control unit (back-calculable type); and
a step of generating the confirmation processing designation on the basis of the function specification information in a case where a result of the determination is a designation of the transaction control unit (confirmable type).
